(19) United States
(12) Patent Application Publication
(10) Pub. No.: US 2006/0214831 A1
(43) Pub. Date: Sep. 28, 2006

(54) Remote controller with ion generator

(76) Inventor: Hsiang-Tang Yu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/086,452

(22) Filed: Mar. 23, 2005

(51) Int. Cl. G08C 19/12

(52) U.S. Cl. 341/176

(57) ABSTRACT

A remote controller (e.g. a TV game controller) adapted and electrically connected with an ion generator, wherein the controller supplies power to the ion generator to produce ions in the surrounding area of the controller to refresh the user of the controller.

### BACKGROUND OF THE INVENTION

(a) Field of the Invention

The present invention is related to a remote controller adapted with an ion generator, and more particularly, to one that refreshes the user of the remote controller.

(b) Description of the Prior Art

A remote controller of the prior art such as one in the form of a TV game controller or a mouse is usually connected to a host for the user to control the host to execute the programs on another end of the TV screen. However, the remote controller is usually used in a room and the quality of the ambient air will get deteriorated after a certain period of time causing the user to feel fatigue.

### SUMMARY OF THE INVENTION

The primary purpose of the present invention is to provide a remote controller adapted with an ion generator to refresh the user of the controller. To achieve the purpose, the ion generator is built in the controller and connected to the control circuit of the controller. While in use, the controller supplies power to the ion generator to produce ions into the ambient air to refresh the user.

### BRIEF DESCRIPTION OF THE DRAWINGS

FIG. 1 is a perspective view of a preferred embodiment of the present invention.

FIG. 2 is a block chart of the preferred embodiment of the present invention.

FIG. 3 is a perspective view of another preferred embodiment of the present invention.

FIG. 4 is a perspective view of another preferred embodiment yet of the present invention.

### DETAILED DESCRIPTION OF THE PREFERRED EMBODIMENTS

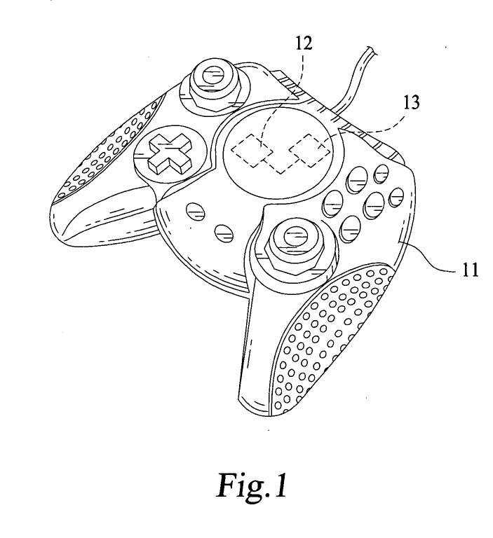

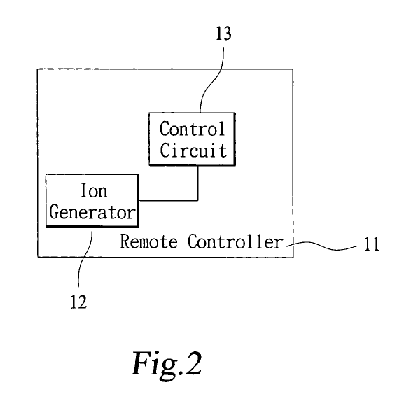

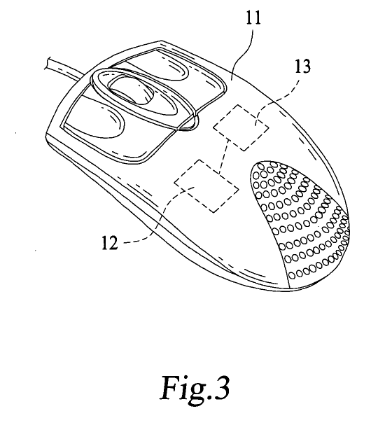

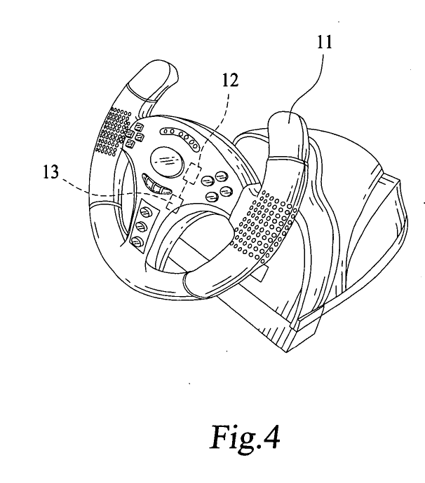

Referring to FIGS. 1 through 4, a preferred embodiment of the present invention is comprised of a remote controller 11 (e.g., one for TV games including racing, a mouse to the computer, etc.) containing an ion generator 12. The ion generator 12 is connected to a control circuit 13 containing a power source of the remote controller 11. When the remote controller 11 is in use, the control circuit 13 of the remote controller 11 supplies power to the ion generator to produce ions into the ambient air of the remote controller. Accordingly, the user is refreshed for inhaling in those ions delivered by the ion generator 12.

Once inhaled, those ions are incorporated with positive electric charges in human body to expel those positive charges out of the human body thus to refresh the user.

The remote controller 11 is connected to a host (not illustrated) for the user to operate the remote controller 11 on the other end of the screen for manipulating the programs executed by the host.

The present invention by providing ions to refresh the user of the remote controller is unique and innovative that has not been introduced in the market and there is the absence of any similar product to the present invention. Therefore, this application for a patent is duly filed accordingly.

It is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

1. A remote controller adapted with an ion generator has the ion generator built in the remote controller and connected to a control circuit of the remote controller; the control circuit containing a power source to supply power to the ion generator to produce ions into the ambient air of the remote controller.

2. The remote controller adapted with an ion generator of claim 1, wherein the remote controller relates to one for a TV game.

3. The remote controller adapted with an ion generator of claim 1, wherein the remote controller relates to one for a car racing TV game.

4. The remote controller adapted with an ion generator of claim 1, wherein the remote controller relates to a mouse of a computer.
